(19) United States
(12) Patent Application Publication
(10) Pub. No.: US 2020/0367447 A1
(43) Pub. Date: Nov. 26, 2020

(54) SELF-CONTAINED PLANT GROW SYSTEM

(71) Applicants: Derek Lissner, Las Vegas, NV (US); Tracy Lissner, Las Vegas, NV (US); Nicole Lissner, Las Vegas, NV (US)

(72) Inventors: Derek Lissner, Las Vegas, NV (US); Tracy Lissner, Las Vegas, NV (US); Nicole Lissner, Las Vegas, NV (US)

(21) Appl. No.: 16/420,786

(22) Filed: May 23, 2019

(51) Int. Cl. A01G 9/02; A01G 9/26; A01G 9/24

(52) U.S. Cl. CPC A01G 9/02; A01G 9/26; A01G 9/241; A01G 9/247; A01G 9/246; A01G 9/249

(57) ABSTRACT

An apparatus for growing plants. The apparatus has an enclosure constructed from a rigid material. The enclosure has at least a main chamber, a middle chamber, and a bottom chamber, each of the main chamber. The main chamber is light proof and water proof Inside the main chamber, a mesh table base is positioned to hold a plurality of plants. The middle chamber is located below the main chamber. A waterproof shelf is located within the middle chamber and is designed to collect any water runoff from the plants. The bottom chamber is located below the middle chamber. The apparatus further has a grow control unit (GCU) located within the enclosure. The GCU has a plurality of control systems including a lighting control system, an environmental control system, irrigation control system, and nutritional control system. An automated control unit (ACU) is located within the bottom chamber. The ACU is configured to automatically manage and monitor the grow conditions within the main chamber based on pre-established grow criteria. In order to adjust the grow conditions, the ACU is connected to the GCS to automatically engage or disengage at least one of the plurality of control systems.

### REFERENCE TO PENDING APPLICATIONS

This application does not claim the benefit of any issued U.S. Patent or pending application.

### TECHNICAL FIELD

The present invention is generally directed toward the growing of plants, and more specifically to a self-contained system to grow plants.

### BACKGROUND

Maintaining proper growing conditions while growing plants can present certain difficulties. Environmental conditions such as light and air quality and humidity need to be properly controlled otherwise plant yield and quality can suffer significantly. Lapses in environmental quality, even temporarily, can negatively impact grow cycles. Additionally, pathogens, such as various molds and rots, along with destructive organisms such as insects also pose a significant threat to growing operations.

Typical prior art growing systems and apparatus are directed toward a large scale growing operation. Such systems are designed to utilized with a large enclosure, having a size of a room or shipping container. These prior art systems have challenges in that they are not conducive for growing operations having space restrictions, such an apartment building, or other types of facilities like this where growing space is limited.

Accordingly, there is a need to satisfy the challenges set out above.

### SUMMARY

The present invention relates generally toward the growing of plants, and more specifically to a self-contained system and apparatus to grow plants.

In one aspect, a system for growing plants is disclosed. The system includes an enclosure being constructed from a rigid material, such a metal. The enclosure is insulated to prevent the interior of the enclosure from being substantially affected by external environmental conditions.

The enclosure has at least a main chamber, a middle chamber, and a bottom chamber. Each of the chambers are separate from the other chambers. The main chamber is light proof and water proof, as well having a mesh table base configured to hold a plurality of plants.

The middle chamber is located below the main chamber. A waterproof shelf is located within the middle chamber and is sloped in order to collect any water runoff from the plants located in the main chamber. A drain hole allows any collected runoff water to be removed from the enclosure.

The bottom chamber is located below the middle chamber. Various operational components are located within the bottom chamber. The enclosure further has at least one access door allowing access to at least one chamber.

The system further includes a grow control unit (GCU) located within the enclosure. The GCU provides the various elements for ensure the successful growing of the plants. These elements can include water, heat, light, nutrients and other elements needed by the plants. The GCU has a plurality of control systems includes a lighting control system, an environmental control system, irrigation control system, and nutritional control system. A portion of the plurality of control systems may be located in the bottom chamber and another portion of the plurality of control systems may be located in the main chamber. For example, the lighting control system may include a light source located in the main chamber in order to provide lighting to the main chamber. The lighting control system may also include a power source and electrical wiring to provide the power from the power source to the light source. The power source and a portion of the electrical wiring may be located in the bottom chamber.

The system also includes an automated control unit (ACU) located primarily within the bottom chamber. The ACU is configured to automatically manage and monitor grow conditions in the main chamber based on pre-established grow criteria. The ACU is connected to the GCS to automatically engage or disengage at least one of the plurality of control systems in order to manage and otherwise modify the grow conditions.

In one aspect, the automated control unit (ACU) may include a plurality of sensor systems where at least one of sensor systems is configured to monitor the conditions relating to one of each of the plurality of control systems. The ACU may also include a plurality of actuators being configured to engage and disengage one of each of the plurality of control systems.

The ACU may also include a processor and a memory device having computer readable instruction stored thereon for execution by the processor, causing the processor to determine pre-established grow criteria, monitor the grow conditions within the main chamber based on data received from the plurality of sensor systems and adjust the grow conditions within the main chamber to conform to the pre-established grow criteria by engaging or disengaging one or more of the plurality of actuators connected to the plurality of control systems.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is a schematic diagram of an embodiment of the present invention.

FIG. 2 is a schematic diagram of an embodiment of main chamber of the present invention.

FIG. 3 is a schematic diagram of an embodiment of middle chamber of the of the present invention.

FIG. 4 is a schematic diagram of an embodiment of bottom chamber of the of the present invention.

FIG. 5 is a schematic diagram of an embodiment of the grow control unit of the present invention.

FIG. 6 is a schematic diagram of an embodiment of the automated control unit of the present invention.

### DETAILED DESCRIPTION FO THE INVENTION

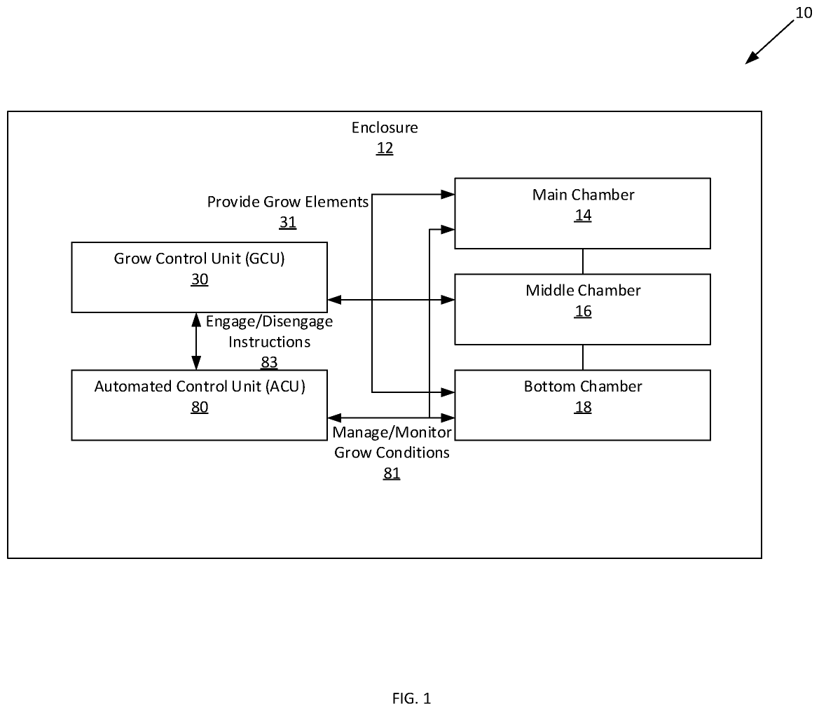

FIG. 1 is a schematic representation of an embodiment of the present invention. This embodiment discloses a system 10 having an enclosure designed for the growing of plants. Enclosure 12 includes a main chamber 14, a middle chamber 16, and a bottom chamber 18. Within these chambers, the plants and the supporting structure is located. Access into these chambers may be through one or more doors or other openings located on with or within enclosure 12. Also included in enclosure 12 is a grow control unit (GCU) 30, which provide the necessary growing elements 31 to the chambers. Also enclosed in enclosure 12 is an automatic control unit (ACU) 80. The ACU monitors the growing conditions of the plants as well as the conditions within the chambers and manages the growing conditions thereof.

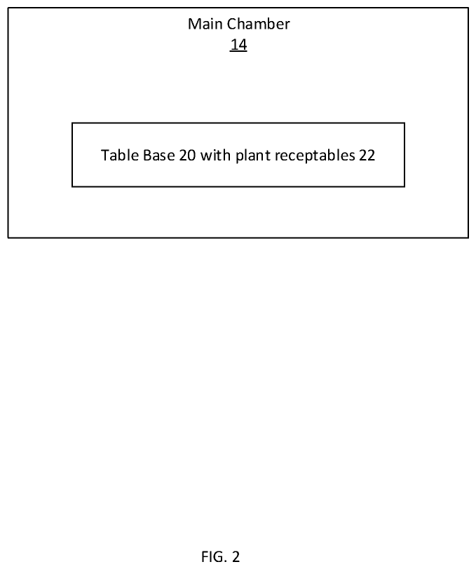

As illustrated in FIG. 2, a schematic representation of an embodiment of main chamber 14 is disclosed. Main chamber 14 includes a table base 20 having a plurality of plant receptacles therein 22. Table base 20 may be constructed of a mesh or other material that is suitable to support a plurality of plants, related soil, and any other element necessary for the growth of the plants. In some embodiments main chamber 14 may include reflective walls to assist with the growth of plants therein.

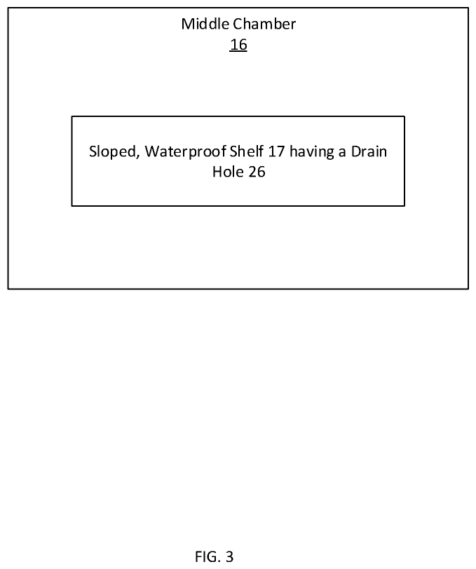

As illustrated in FIG. 3, a schematic representation of an embodiment of middle chamber 16 is disclosed. In this embodiment middle chamber 60 is located directly below main chamber 14. The table base 20 acts as the floor for main chamber 14 and as the ceiling for middle chamber 16. Middle chamber 16 includes a sloped waterproof shelf 17 located below table base 20 and is designed to catch any runoff water exiting the plants located in plant receptacles 22. Shelf 70 includes a drain hole 26 which allows for the evacuation of the collected runoff water. The evacuated runoff water may be removed from the enclosure 12 through a drain hose or other suitable structure. Runoff water may be recycled or otherwise processed for reclamation.

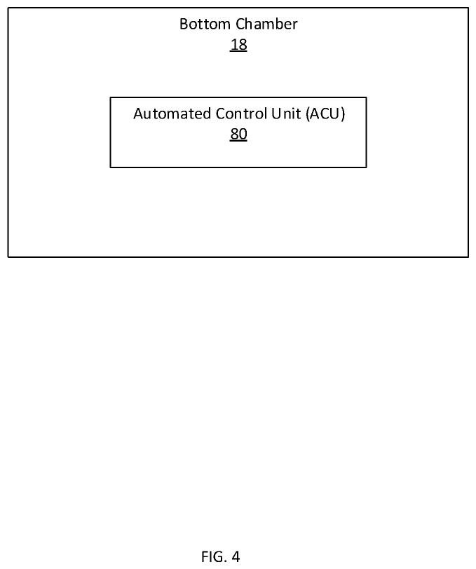

As illustrated in FIG. 4, a schematic representation of bottom chamber 18 is disclosed. In this embodiment bottom chamber 18 is located immediately below middle chamber 16. Located within bottom chamber 18 is a portion of automated control unit 80 and grow control unit 30, both of which will be described in greater detail below.

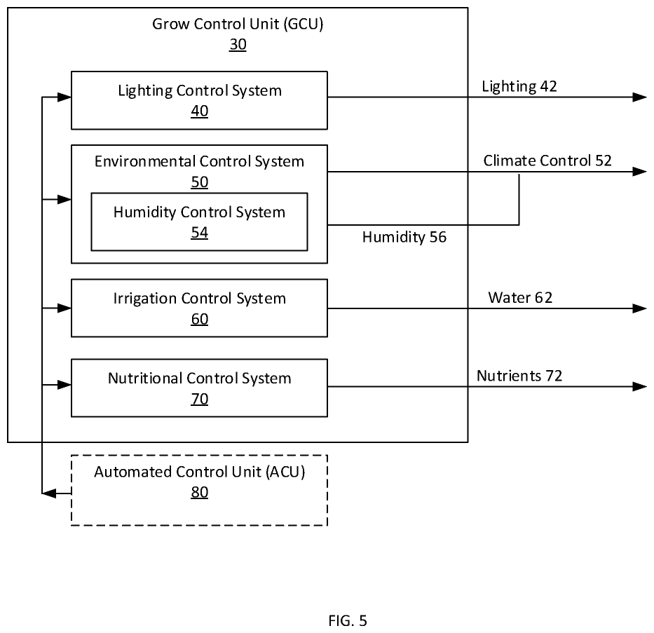

As illustrated in FIG. 5, a schematic representation of grow control unit (GCU) 30 is disclosed. GCU 30 provides the elements necessary for growth 31 to the plants. These elements 31 may include lighting 42, climate control 52, humidity 56, water 62, and nutrients 72. This list of elements is not meant to be exclusive or limiting. Those skilled in the art will recognize that other elements that may assist with the growing of plants may be also included.

In this embodiment, GCU 30 includes a lighting control system 40, and environmental control system 50, and irrigation control system 60, and a nutritional control system 70. GCU 30 is configured to receive instructions and other commands from ACU 80 relating to the growing conditions of the plants within main chamber 14. Based on these instructions and commands one or more of the individual control systems may be engaged or disengaged in order to modify and adjust the growing conditions within main chamber 14.

Lighting control system 40 is designed to provide lighting 42 into main chamber. 14. Lighting control system 40 may include what at least one light connected to standard electrical wiring and related hardware. Power may be provided to lighting control system for through an external power source. The one or more lightbulbs may be a group one or more grow lights, one or more standard illumination, lights, lightbulbs, a combination thereof. The illumination lightbulbs may be light-emitting diode (LED) based lightbulbs or any other suitable lightbulb sufficient to provide the necessary lighting to assist with the growing of the plants located within main chamber 14.

Environmental control system 50 may include heating and cooling assembly providing heat and cooling air into main chamber 14. The heating and cooling assembly may include an air heating and cooling unit located within bottom chamber 18 that provides heat and cooling air into main chamber 14 through a one or more air ducts. Environmental control system 50 may also include a humidity control system 54 that that is configured to provide moisture into main chamber 14 in order to adjust and otherwise control the level of humidity therein. Humidity control system 54 may include a water reservoir located within the bottom chamber eight that provides water droplets into main chamber 14 in order to adjust the level of humidity there. The water droplets may be deposited within main chamber 14 through one or more water nozzles located within main chamber 14 and connected to the water reservoir connecting tubes.

Irrigation control system 60 provides irrigation control to the plants located within main chamber. 14. Irrigation control system 60 may include a water reservoir, which may be the same water reservoir as utilized with the humidity control system. The water reservoir may be connected to an external source of water. Irrigation control system 60 further includes a sprinkler connected to the water reservoir by a water line. The sprinkler provides water 62 to the any leaf or growth portion of the plants. Irrigation control system 60 may also include one or more drip nozzles associated with each receptacle 22. Each drip nozzle is configured to provide water to the soil portion of the plant. The drip nozzles are connected to the water source through a connection line. Additionally, the sprinkler and drip nozzles may be the utilized by both the irrigation control system and the humidity control system.

The nutritional control system 70 provides nutrition 72 to the plants. Nutrition may be in the form of liquid fertilizer or associated growth compounds. The liquid fertilizer may be contained within a nutrient reservoir and may be provided to the plants through a separate nozzle or through the drip nozzle and/or sprinkler utilized with the irrigation control system and or the humidity control system 54.

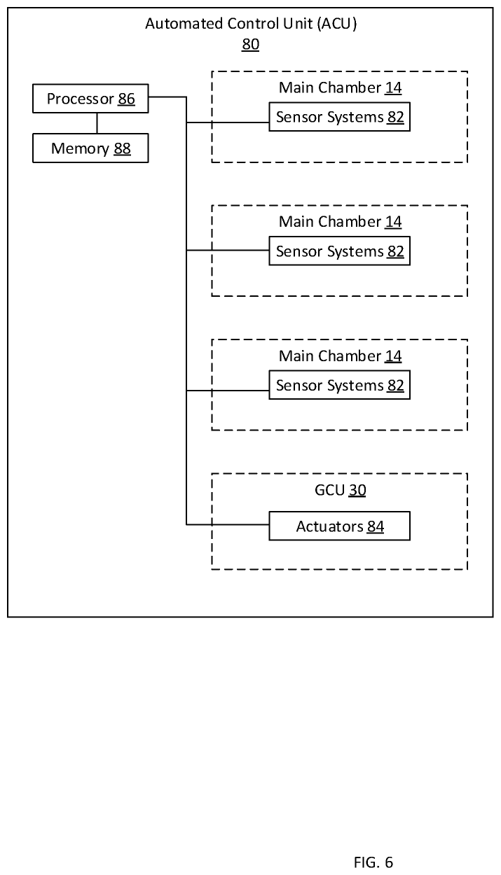

As illustrated in FIG. 6, a schematic representation of the automated control unit (ACU) 80 is disclosed. ACU 80 is configured to provide monitoring and management control over the growth of the plants. Automated control unit includes at least one processor 86 which is configured to act on instructions and commands that are stored in memory 88. ACU 80 include plant growth data that provides details regarding the growth of various plants. These this data include optimal growing conditions and timelines regarding growth, such as optimal temperature, feeding and growing conditions for various plants. Processor 86 and memory 88 are located within bottom chamber 18. A sensor system including a plurality of sensors are located in the main chamber 14, middle chamber 16, and bottom chamber 18 provide ACU 80 with current conditions within such chambers. ACU 80 compares the such current conditions with the optimal conditions of the for the growth of the plants and determines whether any modification to the conditions is needed.

In the event that one or more conditions for optimal growth of the plant is needed. ACU 80 provides instructions to GCU 30 to engage or disengage one or more specific control systems. Engagement or disengagement of the control systems may be effectuated by one or more actuators 84 connected to the various control systems.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A system for growing plants comprising:
an enclosure being constructed from a rigid material, the enclosure being insulated to prevent the interior of the enclosure from being substantially affected by external environmental conditions,
the enclosure having at least a main chamber, a middle chamber, and a bottom chamber, each of the main chamber, the middle chamber and the bottom chamber being separate from the other chambers,
the main chamber having reflective interior walls, the main chamber being light proof and water proof, the main chamber having a mesh table base configured to hold a plurality of plants,
the middle chamber being located below the main chamber, and
the bottom chamber being located below the middle chamber,
the enclosure having at least one access door, the at least one access door allowing access to at least one chamber;
a grow control unit (GCU) located within the enclosure, the GCU having a plurality of control systems,
the plurality of control systems includes a lighting control system, an environmental control system, irrigation control system, and nutritional control system,
wherein the lighting control system provides lighting to the main chamber,
wherein the environmental control system provides heat, cooling and humidity to the main chamber,
wherein the irrigation control system provides water to the main chamber,
wherein the lighting control system provides nutrients to the main chamber;
a waterproof shelf located within the middle chamber, the shelf configured to collect any water runoff from the plants located in the main chamber, the shelf being sloped and having a drainhole; and
an automated control unit (ACU) located within the enclosure, the ACU configured to automatically manage and monitor grow conditions based on pre-established grow criteria, the ACU being connected to the GCS to automatically engage or disengage at least one of the plurality of control systems.

2. The system of claim 1, wherein the rigid material is metal.

3. The system of claim 1, wherein the reflective interior walls are constructed from at least aluminum.

4. The system of claim 1, wherein the environmental control system includes a humidity control system configured to control levels of humidity inside the enclosure.

5. The system of claim 1, wherein the plurality of control systems further includes an air filtration control system.

6. The system of claim 1, wherein a part of the plurality of control systems is located in the bottom chamber and a part of the plurality of control systems is located in the middle chamber.

7. The system of claim 1, wherein the automated control unit (ACU) comprising:
a plurality of sensor systems, at least one of the plurality of sensor systems being configured to monitor conditions relating to one of each of the plurality of control systems;
a plurality of actuators, at least one of the plurality of actuators being configured to engage and disengage one of each of the plurality of control systems;
a processor; and
a memory device, having computer readable instruction stored thereon for execution by the processor, causing the processor to:
determine pre-established grow criteria;
monitoring grow conditions within the main chamber based on data received from the plurality of sensor systems; and
adjusting grow conditions within the main chamber to conform to the pre-established grow criteria by engaging or disengaging one or more of the plurality of actuators connected to the plurality of control systems.

8. The system of claim 7, wherein the automated control unit (ACU) further comprising:
an external control pad located on an external surface of the enclosure, the external control pad configured to provide grow conditions based on data received from the plurality of sensor systems.
